(19) United States
(12) Patent Application Publication
(10) Pub. No.: US 2025/0051234 A1
(43) Pub. Date: Feb. 13, 2025

(54) Gypsum Panel Containing An Enzyme Composition

(71) Applicant: Gold Bond Building Products, LLC, Charlotte, NC (US)

(72) Inventors: Xing Yang, Charlotte, NC (US); Ratnasabapathy Gurunathan Iyer, Charlotte, NC (US); Joseph J. Bailey, Charlotte, NC (US)

(21) Appl. No.: 18/795,282

(22) Filed: Aug. 6, 2024

Related U.S. Application Data
(60) Provisional application No. 63/519,032, filed on Aug. 11, 2023.

(51) Int. Cl. C04B 24/14; B32B 13/02; B32B 13/04; B32B 37/15; C04B 24/12; C04B 28/14; C04B 111/00; E04C 2/04

(52) U.S. Cl. CPC C04B 24/14; B32B 13/02; B32B 13/04; B32B 37/15; C04B 22/10; C04B 24/126; C04B 28/14; E04C 2/04; B32B 2250/40; B32B 2264/104; B32B 2264/303; B32B 2607/00; C04B 2111/0062

(57) ABSTRACT

The present invention is directed to a gypsum panel including an enzyme composition and a method of making such gypsum panel. For instance, in one embodiment, the gypsum panel comprises a gypsum core and a first facing material and a second facing material sandwiching the gypsum core, wherein the gypsum core is formed from a gypsum slurry including an enzyme composition and an amide composition. The methods of the present invention are directed to making the aforementioned gypsum panels by providing the first facing material, providing a gypsum slurry comprising gypsum, water, an enzyme composition, and an amide composition onto the first facing material, and providing a second facing material on the gypsum slurry.

### RELATED APPLICATIONS

The present application is based upon and claims priority to U.S. Provisional Patent Application Ser. No. 63/519,032, having a filing date of Aug. 11, 2023, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the stucco with the water. In modern times, corporate sustainability initiatives and national environmental initiatives have become increasingly prominent and influential. Indeed, the sequestration of carbon dioxide has become an important aspect in reducing the carbon footprint of various industries, including the construction industry. Namely, the sequestration of carbon dioxide in gypsum panels may be particularly advantageous.

Thus, there is a need to provide an improved gypsum panel that sequesters carbon dioxide.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises: a gypsum core formed from a gypsum slurry comprising an enzyme composition and an amide composition, the amide composition being present in the gypsum slurry in an amount from about 0.01 wt. % to about 5 wt. %; and a first facing material and a second facing material sandwiching the gypsum core.

In accordance with another embodiment of the present invention, a method of making a gypsum panel is disclosed. The method comprises: providing a first facing material; depositing a gypsum slurry comprising stucco, water, an enzyme composition, and an amide composition onto the first facing material, the amide composition being present in the gypsum slurry in an amount from about 0.01 wt. % to about 5 wt. %; providing a second facing material on the gypsum slurry; and allowing the stucco to convert to calcium sulfate dihydrate.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core including an enzyme composition and/or an amide composition as defined herein. In this regard, the gypsum core may include gypsum (i.e., calcium sulfate dihydrate), an amide composition, an enzyme composition, and may include other optional additives. The present inventors have discovered that the gypsum panel disclosed herein can have various benefits due to the use of an amide composition and/or an enzyme composition. For instance, the present inventors have discovered that the mechanical properties and characteristics of the gypsum panel may be improved. For instance, the gypsum panel disclosed herein may have increased nail pull resistance, increased panel strength, enhanced carbon sequestration, enhanced fire resistance, and/or self-healing properties.

In general, a gypsum panel formed in accordance with the present disclosure may be more sustainable or environmentally friendly as compared to a traditional gypsum panel. For instance, a gypsum panel formed in accordance with the present disclosure may minimize the formation of carbon dioxide. In this respect, carbon dioxide that is generally released during the application of urea may be sequestered and/or reduced by the incorporation of urea in a gypsum panel formed in accordance with the present disclosure.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present invention may omit one or more of the features disclosed herein.

In general, the gypsum core may comprise calcium sulfate dihydrate. The gypsum may be from a natural source, a synthetic source, and/or reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In addition to gypsum, the gypsum core may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material in the gypsum core.

In general, the gypsum core and/or gypsum slurry may comprise one or more enzyme compositions. In general, one or more enzyme compositions of the present disclosure may include one or more enzymes. For instance, an enzyme composition may include urease, carbonic anhydrase, nitrate reductase, nitrite reductase, asparaginase, protease, adenosine deaminase, or a combination thereof. In some aspects, two or more enzyme compositions and/or enzymes may be selectively chosen to form a combination of enzyme compositions and/or enzymes that synergistically interact to enhance one or more properties of a gypsum panel formed in accordance with the present disclosure.

In one aspect, the gypsum core and/or gypsum slurry may comprise one or more amide compositions. Generally, an amide composition may comprise one or more primary amides, one or more secondary amides, one or more tertiary amides, or a combination thereof. For instance, in one aspect, an amide composition may include urea, which generally has the chemical formula CO(NH₂)₂. Notably, urea is generally formed from the reaction of ammonia with carbon dioxide. Upon the application of urea, such as the application of urea as a soil additive, urea undergoes a hydrolysis reaction resulting in the production of ammonia and carbon dioxide. Notably, the carbon dioxide is generally released into the atmosphere.

Generally, an enzyme composition and/or an amide composition may be present in any component of the disclosed gypsum panel. For instance, as previously disclosed herein, an enzyme composition and/or an amide composition may be present in the gypsum slurry and/or the gypsum core of the gypsum panel. Further, for instance, an enzyme composition and/or an amide composition may be present in one or more gypsum core layers (e.g., first gypsum core layer, second gypsum core layer, third gypsum core layer) of the gypsum panel. Additionally or alternatively, for instance, an enzyme composition and/or an amide composition may be present in or on one or more of the facing materials of the gypsum panel.

In general, an enzyme composition and/or an amide composition may be in the form of a solid (e.g., powder, fines, granules), a liquid, or a combination thereof. In general, an enzyme composition and/or an amide composition may be applied to or incorporated in any component of a gypsum panel in the form of a solid, a liquid (e.g., a solution), or a combination (e.g., a dispersion) thereof. As used herein, the term “dispersion” refers to a liquid having solid particles dispersed therein. In one aspect, the liquid of a dispersion may be water and the solid particles of the dispersion may be an enzyme composition and/or an amide composition.

Generally, an enzyme composition and an amide composition may react in the gypsum slurry and/or the gypsum core to form at least one reaction product (e.g., carbonate, ammonium). In general, the ammonium may react with one or more anions present in a gypsum slurry. In one aspect, as previously disclosed herein, an amide composition may comprise urea. Notably, when urea is treated and/or reacted with an enzyme composition, such as an enzyme composition including urease, the urea may be converted into carbonate and ammonium. For instance, urea may undergo the following reaction, Reaction 1, when treated and/or combined with an enzyme composition:

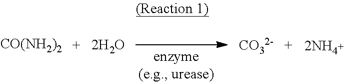

As previously discussed herein, urea generally converts into ammonia and carbon dioxide. However, the utilization of the enzyme composition of the present disclosure may result in the formation of ammonium ions and carbonate ions. Notably, in some aspects, in addition to ammonium ions and carbonate ions, bicarbonate and ammonia may be products of Reaction 1. The resulting carbonate ions formed in Reaction 1 may increase the pH of a gypsum panel component (e.g., gypsum slurry, gypsum core) in which the urea is present. For instance, the pH of a gypsum slurry and/or gypsum core formed in accordance with the present disclosure may be from about 6 to about 11, such as a pH of about 6 or more, such as about 7 or more, such as about 8 or more, such as about 9 or more, such as about 10 or more, such as about 11 or less, such as about 10 or less, such as about 9 or less, such as about 8 or less, such as about 7 or less. In one particular aspect, the resulting carbonate ions formed in Reaction 1 may result in a gypsum slurry and/or gypsum core having a pH from about 8 to about 10. Notably, such a pH range may be particularly advantageous for the cross-linking of silicone and other additives, which may provide enhanced water resistance and other properties to a gypsum panel. In this respect, combining urea and an enzyme composition, such as an enzyme composition comprising urease, in a gypsum slurry and/or gypsum core may enhance the water resistance and/or air and water barrier properties of a gypsum panel.

In one aspect, the gypsum core and/or gypsum slurry of the present disclosure may include one or more monovalent cations, one or more divalent cations, one or more trivalent cations, or a combination thereof. For instance, a gypsum core and/or gypsum slurry formed in accordance with the present disclosure may include calcium, magnesium, or a combination thereof. In one aspect, the formation of a gypsum core and/or gypsum slurry may include contacting stucco (i.e., calcium sulfate hemihydrate) with water to form the gypsum (i.e., calcium sulfate dihydrate) of the gypsum core and/or gypsum slurry. For instance, stucco may undergo the following reaction when reacted with water, such as during gypsum formation:

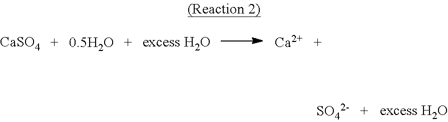

As disclosed in the above reaction, Reaction 2, the reaction of stucco and water may form calcium ions and sulfate ions. In this respect, the reaction of stucco and water may form one or more divalent cations (e.g., calcium). Generally, excess water may be utilized to enhance the fluidity of the gypsum slurry and/or to enhance the conversion of the majority or all of the stucco into gypsum.

In one aspect, the presence of one or more cations in the gypsum core and/or gypsum slurry may be particularly advantageous. For instance, in one aspect, one or more cations may react with the products of Reaction 1. In this respect, one or more cations (e.g., calcium) may react with carbonate. Notably, one or more cations, such as calcium, may react with the reaction products of the enzyme composition and the amide composition to form one or more metal carbonates. For instance, in one aspect, the reaction of calcium and carbonate in a gypsum core and/or gypsum slurry may form calcium carbonate. In this respect, calcium and carbonate may undergo the following reaction in a gypsum core and/or gypsum slurry:

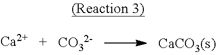

Generally, the formation of calcium carbonate in a gypsum core and/or gypsum slurry may be advantageous. For instance, the carbonate ions formed via Reaction 1 may bond with one or more cations (e.g., calcium) such that carbon dioxide is sequestered in a gypsum panel formed in accordance with the present disclosure. In this respect, the carbon dioxide that is traditionally released upon the application of urea may be sequestered in a gypsum panel formed in accordance with the present disclosure.

Further, the formation of calcium carbonate in a gypsum core and/or gypsum slurry may provide other advantages. For instance, the formation of calcium carbonate may enhance the nail pull resistance, panel strength, carbon sequestration, self-healing, and fire resistance properties of a gypsum panel. Further, in one aspect, the ammonium produced from the reaction of the urea and an enzyme composition, such as an enzyme composition comprising urease, may react with the sulfate ions of Reaction 2 to form ammonium sulfate. Notably, when heated, ammonium sulfate may convert into nitrogen and water, which may enhance the fire resistance properties of a gypsum panel. Further, calcium carbonate may enhance the fire resistance properties of a gypsum panel. In this respect, when exposed to high temperatures, calcium carbonate may form calcium oxide and carbon dioxide, which may enhance the fire resistance properties of a gypsum panel.

The enzyme composition may be present in and/or applied to the gypsum panel in an amount of 0.001 lbs/MSF to 125 lbs/MSF, including all increments of 0.001 lbs/MSF therebetween. For instance, the enzyme composition may be present in and/or applied to the gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more, such as 50 lbs/MSF or more, such as 60 lbs/MSF or more, such as 70 lbs/MSF or more, such as 80 lbs/MSF or more, such as 90 lbs/MSF or more, such as 100 lbs/MSF or more. Generally, the enzyme composition may be present in and/or applied to the gypsum panel in an amount of 125 lbs/MSF or less, such as 100 lbs/MSF or less, such as 90 lbs/MSF or less, such as 80 lbs/MSF or less, such as 70 lbs/MSF or less, such as 60 lbs/MSF or less, such as 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less, such as 0.75 lbs/MSF or less, such as 0.5 lbs/MSF or less, such as 0.25 lbs/MSF or less, such as 0.2 lbs/MSF or less, such as 0.1 lbs/MSF or less.

Further, in some aspects, an enzyme composition may be present in the gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more. In some aspects, the enzyme composition may be present in the gypsum panel and/or any component thereof in an amount of 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In general, an enzyme composition may comprise enzyme-producing bacteria and/or one or more biologically-derived enzyme additives (e.g., one or more plant-derived enzyme additives, one or more fungi-derived enzyme additives, one or more algae-derived enzyme additives). It should be understood that the one or more plant-derived enzyme additives, one or more fungi-derived enzyme additives, and/or one or more algae-derived enzyme additives may comprise one or more enzymes. For instance, the one or more plant-derived enzyme additives, one or more fungi-derived enzyme additives, and/or one or more algae-derived enzyme additives may comprise urease, carbonic anhydrase, nitrate reductase, nitrite reductase, asparaginase, protease, adenosine deaminase, or a combination thereof. Further, it should be understood that the enzyme-producing bacteria may produce urease, carbonic anhydrase, nitrate reductase, nitrite reductase, asparaginase, protease, adenosine deaminase, or a combination thereof.

In general, a biologically-derived enzyme additive may be derived from a plant. For instance, a plant-derived enzyme additive may be derived from the seeds, leaves, roots, stems, flowers, and/or fruit of one or more plants. In one aspect, a plant-derived enzyme additive may be derived from soybeans, black beans, jack beans, kidney beans, lima beans, peanuts, legumes (e.g., chickpeas, lentils, alfalfa), oil seeds (e.g., rapeseed, canola, sunflower), rice, wheat, maize, oats, barley, clover, jackfruit, or a combination thereof.

In general, a biologically-derived enzyme additive (e.g., a plant-derived enzyme additive) may have an enzyme (e.g., urease) content from about 0.01 wt. % to about 20 wt. %, including all increments of 0.01 wt. % therebetween, by weight of the biologically-derived enzyme additive. For instance, a biologically-derived enzyme additive (e.g., a plant-derived enzyme additive) may have an enzyme (e.g., urease) content of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 12 wt. % or more, such as about 14 wt. % or more, such as about 16 wt. % or more, such as about 18 wt. % or more. In general, a biologically-derived enzyme additive (e.g., a plant-derived enzyme additive) may have an enzyme (e.g., urease) content of about 20 wt. % or less, such as about 18 wt. % or less, such as about 16 wt. % or less, such as about 14 wt. % or less, such as about 12 wt. % or less, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

Generally, a biologically-derived enzyme additive (e.g., a plant-derived enzyme additive) may be in the form of a solid (e.g., powder, fines, granules), a liquid, or a mixture thereof. In general, a biologically-derived enzyme additive may be applied to or incorporated in any component of a gypsum panel in the form of a solid, a liquid (e.g., a solution), or a combination (e.g., a dispersion) thereof. As used herein, the term “dispersion” refers to a liquid having solid particles dispersed therein. In one aspect, the liquid of a dispersion may be water and the solid particles of the dispersion may be one or more biologically-derived enzyme additives.

In general, a biologically-derived enzyme additive may have a selectively chosen average particle size. For instance, a biologically-derived enzyme additive (e.g., a plant-derived enzyme additive) may have an average particle size of 5 mm or less, such as 4.5 mm or less, such as 4 mm or less, such as 3.5 mm or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The biologically-derived enzyme additive may have an average particle size of 1 nanometer or more, such as 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 25 microns or more, such as 40 microns or more, such as 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 3.5 mm or more, such as 4 mm or more, such as 4.5 mm or more. Furthermore, in one aspect, the aforementioned values may refer to a median particle size of a biologically-derived enzyme additive and/or any components thereof. In this respect, the biologically-derived enzyme additive may have a D10, D50, or D90 of any of the values previously disclosed, including any incremental values therebetween.

The enzyme-producing bacteria and/or one or more biologically-derived enzyme additives (e.g., one or more plant-derived enzyme additives, one or more fungi-derived enzyme additives, one or more algae-derived enzyme additives) may be present in and/or applied to the gypsum panel in an amount of 0.001 lbs/MSF to 125 lbs/MSF, including all increments of 0.001 lbs/MSF therebetween. For instance, the enzyme-producing bacteria and/or one or more biologically-derived enzyme additives (e.g., one or more plant-derived enzyme additives, one or more fungi-derived enzyme additives, one or more algae-derived enzyme additives) may be present in and/or applied to the gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more, such as 50 lbs/MSF or more, such as 60 lbs/MSF or more, such as 70 lbs/MSF or more, such as 80 lbs/MSF or more, such as 90 lbs/MSF or more, such as 100 lbs/MSF or more. Generally, the enzyme-producing bacteria and/or one or more biologically-derived enzyme additives (e.g., one or more plant-derived enzyme additives, one or more fungi-derived enzyme additives, one or more algae-derived enzyme additives) may be present in and/or applied to the gypsum panel in an amount of 125 lbs/MSF or less, such as 100 lbs/MSF or less, such as 90 lbs/MSF or less, such as 80 lbs/MSF or less, such as 70 lbs/MSF or less, such as 60 lbs/MSF or less, such as 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less, such as 0.75 lbs/MSF or less, such as 0.5 lbs/MSF or less, such as 0.25 lbs/MSF or less, such as 0.2 lbs/MSF or less, such as 0.1 lbs/MSF or less.

Further, in some aspects, an enzyme-producing bacteria and/or one or more biologically-derived enzyme additives (e.g., one or more plant-derived enzyme additives, one or more fungi-derived enzyme additives, one or more algae-derived enzyme additives) may be present in the gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more. In some aspects, an enzyme-producing bacteria and/or one or more biologically-derived enzyme additives (e.g., one or more plant-derived enzyme additives, one or more fungi-derived enzyme additives, one or more algae-derived enzyme additives) may be present in the gypsum panel and/or any component thereof in an amount of 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In general, the enzyme-producing bacteria and/or one or more biologically-derived enzyme additives (e.g., one or more plant-derived enzyme additives, one or more fungi-derived enzyme additives, one or more algae-derived enzyme additives) may be present in an enzyme composition in an amount from about 0.01 wt. % to about 100 wt. %, including all increments of 0.01 wt. % therebetween. For instance, the enzyme-producing bacteria and/or one or more biologically-derived enzyme additives (e.g., one or more plant-derived enzyme additives, one or more fungi-derived enzyme additives, one or more algae-derived enzyme additives) may be present in an enzyme composition in an amount of about 0.01 wt. % or more, such as about 1 wt. % or more, such as about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more, such as about 100 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 10 wt. % or less.

Generally, the enzyme-producing bacteria and/or one or more biologically-derived enzyme additives (e.g., one or more plant-derived enzyme additives, one or more fungi-derived enzyme additives, one or more algae-derived enzyme additives) may have a selectively chosen particle size distribution. The particle size distribution of the enzyme-producing bacteria and/or one or more biologically-derived enzyme additives may be monomodal, bi-modal, or multi-modal. The one or more modes may fall within any of the particle size values, including any ranges thereof, disclosed herein. In some aspects, a US standard mesh size of 4 (i.e., 4.75 mm) to 400 (i.e., 0.038 mm) may retain from 0 wt. % to about 100 wt. % of the enzyme-producing bacteria and/or one or more biologically-derived enzyme additives, including all increments of 0.01 wt. % therebetween. In some aspects, the aforementioned percentage values may be based on volume percent.

As previously disclosed herein, a gypsum core and/or gypsum slurry formed in accordance with the present disclosure may include one or more amide compositions. Generally, an amide composition may have a nitrogen content of about 10 wt. % to about 70 wt. %, including all increments of 0.1 wt. % therebetween. For instance, the amide composition may have a nitrogen content of about 10 wt. % or more, such as about 20 wt. % or more, such as about 30 wt. % or more, such as about 40 wt. % or more, such as about 50 wt. % or more, such as about 60 wt. % or more, such as about 70 wt. % or less, such as about 60 wt. % or less, such as about 50 wt. % or less, such as about 40 wt. % or less, such as about 30 wt. % or less, such as about 20 wt. % or less.

In general, an amide composition may have a formaldehyde content of about 0 wt. % to about 10 wt. %, including all increments of 0.1 wt. % therebetween. For instance, the amide composition may have a formaldehyde content of about 0 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 2 wt. % or more, such as about 5 wt. % or more. Generally, an amide composition has a formaldehyde content of about 10 wt. % or less, such as about 8 wt. % or less, such as about 5 wt. % or less, such as about 2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less. In some aspects, the amide composition may be substantially free of formaldehyde. As used herein, an amide composition “substantially free” of formaldehyde has a formaldehyde content of less than about 2 wt. %.

In some aspects, an amide composition may have a biuret content of about 0 wt. % to about 10 wt. %, such as about 0 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 2 wt. % or more, such as about 5 wt. % or more. Generally, an amide composition has a biuret content of about 10 wt. % or less, such as about 8 wt. % or less, such as about 5 wt. % or less, such as about 2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less. In some aspects, the amide composition may be substantially free of biuret. As used herein, an amide composition “substantially free” of biuret has a biuret content of less than about 2 wt. %.

Generally, the amide composition may have a bulk density from about 500 kg/m³ to about 1000 kg/m³, such as about 500 kg/m³ or more, such as about 600 kg/m³ or more, such as about 700 kg/m³ or more, such as about 800 kg/m³ or more, such as about 900 kg/m³ or more. In general, the amide composition may have a bulk density of about 1000 kg/m³ or less, such as about 900 kg/m³ or less, such as about 800 kg/m³ or less, such as about 700 kg/m³ or less, such as about 600 kg/m³ or less.

In order to provide the desired effect, an amide composition may have a selectively chosen average particle size. For instance, an amide composition may have an average particle size of 5 mm or less, such as 4.5 mm or less, such as 4 mm or less, such as 3.5 mm or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 20 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The amide composition may have an average particle size of 1 nanometer or more, such as 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 25 microns or more, such as 40 microns or more, such as 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 3.5 mm or more, such as 4 mm or more, such as 4.5 mm or more. Furthermore, in one aspect, the aforementioned values may refer to a median particle size of the amide composition. In this respect, the amide composition may have a D₁₀, D₅₀, or D₉₀ Of any of the values previously disclosed, including any incremental values therebetween.

Generally, the amide composition may have a selectively chosen particle size distribution. The particle size distribution of the amide composition may be monomodal, bi-modal, or multi-modal. The one or more modes may fall within any of the particle size values, including any ranges thereof, disclosed herein. In one aspect, a US standard mesh size of 4 (i.e., 4.75 mm) to 50 (i.e., 0.3 mm) may retain from 0 wt. % to about 100 wt. % of the amide composition, including all increments of 0.01 wt. % therebetween. In some aspects, a US standard mesh size of 6 may retain about 10 wt. % to about 30 wt. % of the amide composition, such as about 10 wt. % or more, such as about 15 wt. % or more, such as about 20 wt. % or more, such as about 25 wt. % or more, such as about 30 wt. % or less, such as about 25 wt. % or less, such as about 20 wt. % or less, such as about 15 wt. % or less. In some aspects, a US standard mesh size of 7 may retain about 50 wt. % to about 85 wt. % of the amide composition, such as about 50 wt. % or more, such as about 60 wt. % or more, such as about 70 wt. % or more, such as about 80 wt. % or more, such as about 85 wt. % or less, such as about 80 wt. % or less, such as about 70 wt. % or less, such as about 60 wt. % or less. In some aspects, a US standard mesh size of 10 may retain about 90 wt. % to about 100 wt. % of the amide composition, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In some aspects, a US standard mesh size of 18 may retain about 90 wt. % to about 100 wt. % of the amide composition, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In some aspects, a US standard mesh size of 30 may retain about 90 wt. % to about 100 wt. % of the amide composition, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In some aspects, the aforementioned percentage values may be based on volume percent.

The amide composition may be present in and/or applied to the gypsum panel in an amount of 0.001 lbs/MSF to 125 lbs/MSF, including all increments of 0.001 lbs/MSF therebetween. For instance, the amide composition may be present in and/or applied to the gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more, such as 50 lbs/MSF or more, such as 60 lbs/MSF or more, such as 70 lbs/MSF or more, such as 80 lbs/MSF or more, such as 90 lbs/MSF or more, such as 100 lbs/MSF or more. Generally, the amide composition may be present in and/or applied to the gypsum panel in an amount of 125 lbs/MSF or less, such as 100 lbs/MSF or less, such as 90 lbs/MSF or less, such as 80 lbs/MSF or less, such as 70 lbs/MSF or less, such as 60 lbs/MSF or less, such as 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less, such as 0.75 lbs/MSF or less, such as 0.5 lbs/MSF or less, such as 0.25 lbs/MSF or less, such as 0.2 lbs/MSF or less, such as 0.1 lbs/MSF or less.

Further, in some aspects, an amide composition may be present in the gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more. In some aspects, the amide composition may be present in the gypsum panel and/or any component thereof in an amount of 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In general, the concentration of an amide composition and/or calcium carbonate may be higher in the area of the gypsum core near a respective facing material and may decrease across a thickness of the gypsum core. In one aspect, any of the respective gypsum core layers (e.g., first gypsum core layer, second gypsum core layer, third gypsum core layer) may have a higher concentration of the amide composition and/or calcium carbonate than the other gypsum core layers. For instance, in one aspect, the first gypsum core layer and/or third gypsum core layer may have a higher concentration of an amide composition and/or calcium carbonate than the second gypsum core layer. In some aspects, one or more gypsum core layers may be free of an amide composition and/or calcium carbonate.

Generally, the amide composition and/or calcium carbonate may be heterogeneously or nonuniformly dispersed in the gypsum core. In some aspects, the concentration of the amide composition and/or calcium carbonate may be such that a concentration gradient of the amide composition and/or calcium carbonate is formed in a gypsum core. In some aspects, the concentration gradient may be such that the concentration of the amide composition and/or calcium carbonate increases or decreases over a portion of a thickness, such as a thickness disclosed herein, of a gypsum core formed in accordance with the present disclosure. In one aspect, a gypsum core formed in accordance with the present disclosure may have a higher concentration of the amide composition and/or calcium carbonate in the portion of the gypsum core adjacent to the first facing material (e.g., the first gypsum core layer) with the concentration of the amide composition and/or calcium carbonate decreasing across a dimension (e.g., the thickness) of the gypsum core. In general, in one aspect, the concentration of the amide composition and/or calcium carbonate in the gypsum core may decrease across a thickness of a gypsum core beginning at the portion of the gypsum core adjacent the first facing material and ending at the portion of the gypsum core adjacent the second facing material.

In one aspect, a gypsum core (e.g., set gypsum core) formed in accordance with the present disclosure may have a higher concentration of the amide composition and/or calcium carbonate in the portion of the gypsum core adjacent to the second facing material (e.g., the third gypsum core layer) with the concentration of the amide composition and/or calcium carbonate decreasing across a dimension (e.g., the thickness) of the gypsum core. As used herein, a “set gypsum core” refers to the gypsum core after the drying process of the gypsum panel, which may include drying the gypsum panel in a heating or drying device (e.g., kiln). In general, in one aspect, the concentration of the amide composition and/or calcium carbonate in the gypsum core may decrease across the thickness of a gypsum core beginning at the portion of the gypsum core adjacent the second facing material and ending at the portion of the gypsum core adjacent the first facing material.

In one aspect, a gypsum core (e.g., set gypsum core) formed in accordance with the present disclosure may have a higher concentration of the amide composition and/or calcium carbonate in the portion of the gypsum core adjacent to the first facing material as compared to the concentration of the amide composition and/or calcium carbonate in the portion of the gypsum core adjacent to the second facing material. In this respect, the concentration of the amide composition and/or calcium carbonate in the portion of the gypsum core adjacent to the first facing material may be higher than the concentration of the amide composition and/or calcium carbonate in the portion of the gypsum core adjacent to the second facing material. In another aspect, a gypsum core (e.g., set gypsum core) formed in accordance with the present disclosure may have a higher concentration of the amide composition and/or calcium carbonate in the portion of the gypsum core adjacent to the second facing material as compared to the concentration of the amide composition and/or calcium carbonate in the portion of the gypsum core adjacent to the first facing material. In this respect, the concentration of the amide composition and/or calcium carbonate in the portion of the gypsum core adjacent to the second facing material may be higher than the concentration of the amide composition and/or calcium carbonate in the portion of the gypsum core adjacent to the first facing material.

In yet another aspect, the concentration of the amide composition and/or calcium carbonate in the gypsum core (e.g., set gypsum core) may be higher in the portions of the gypsum core adjacent to the respective facing materials (e.g., the first gypsum core layer and the third gypsum core layer). For instance, the concentration of the amide composition and/or calcium carbonate in the gypsum core may be higher in the portions of the gypsum core adjacent the first facing material and the second facing material, as compared to the center of the thickness of the gypsum core. It should be understood that the center of the thickness of the gypsum core is parallel to one or more respective facing materials and is a plane that extends the length and width of the gypsum core. In one aspect, a gypsum core formed in accordance with the present disclosure may have a higher concentration of the amide composition and/or calcium carbonate adjacent to the first facing material and the second facing material with the concentration of the amide composition and/or calcium carbonate decreasing toward the center of the thickness of the gypsum core beginning at the portions of the gypsum core adjacent the first facing material and second facing material respectively.

Notably, in one aspect, the three highest concentrations of the amide composition and/or calcium carbonate in a gypsum core (e.g., set gypsum core) may be at the portion of the gypsum core adjacent the first facing material, at the center of the thickness of the gypsum core, and at the portion of the gypsum core adjacent the second facing material respectively. In this respect, the area of a gypsum core between the portion of the gypsum core adjacent the first facing material and the center of the thickness of the gypsum core may have a reduced concentration of the amide composition and/or calcium carbonate compared to the concentration of the amide composition and/or calcium carbonate in the portion of the gypsum core adjacent the first facing material and the center of the thickness of the gypsum core. Further, the area of a gypsum core between the portion of the gypsum core adjacent the second facing material and the center of the thickness of the gypsum core may have a reduced concentration of the amide composition and/or calcium carbonate compared to the concentration of the amide composition and/or calcium carbonate in the portion of the gypsum core adjacent the second facing material and the center of the thickness of the gypsum core.

It should be understood that the portion of the gypsum core adjacent to the first facing material may be referred to as the first gypsum core layer. Additionally, when the gypsum core includes two gypsum core layers, the portion of the gypsum core adjacent to the second facing material may be referred to as the second gypsum core layer. Further, when the gypsum core includes three gypsum core layers, the portion of the gypsum core adjacent to the second facing material may be referred to as the third gypsum core layer.

In one aspect, the ratio of the concentration of the amide composition and/or calcium carbonate at the interface of the gypsum core and a facing material (e.g., the first facing material, the second facing material) to the concentration of the amide composition and/or calcium carbonate at the center of the thickness of the gypsum core may be from about 1:1 to about 1:20, such as about 1:1 or more, such as about 1:5 or more, such as about 1:10 or more, such as about 1:15 or more. In general, the ratio of the concentration of the amide composition and/or calcium carbonate at the interface of the gypsum core and a facing material (e.g., the first facing material, the second facing material) to the concentration of the amide composition and/or calcium carbonate at the center of the thickness of the gypsum core may be about 1:20 or less, such as about 1:15 or less, such as about 1:10 or less, such as about 1:5 or less, including all incremental ratios therebetween.

In one aspect, the conversion time of an amide composition, such as urea, to carbonate and ammonium ions via Reaction 1 may be delayed and/or extended. Notably, in one aspect, a delayed conversion time may allow for the gypsum core to have self-healing properties. In this respect, a delayed conversion time may allow the delayed production of carbonate ions that may combine with metal cations (e.g., calcium) to form products, such as metal carbonates (e.g., calcium carbonate), that provide self-healing properties to a gypsum panel.

In one aspect, the conversion time of an amide composition into the desired conversion products may be delayed and/or extended by adjusting the concentration of the one or more enzyme compositions, the one or more amide compositions, and/or the water content of a gypsum slurry and/or gypsum core.

In one aspect, at least a portion of an amide composition and/or any components thereof may be coated or encapsulated with one or more encapsulating or coating materials to delay and/or extend the conversion time of an amide composition, such as the conversion time of urea into carbonate and ammonium. For instance, the encapsulation or coating may prevent or inhibit at least a portion of the amide composition from coming into contact with water, moisture, and/or an enzyme composition during the manufacturing process of a gypsum panel. In some aspects, a coating or encapsulation may be capable of dissolving or melting, such as with exposure to water, pressure, and/or temperature. For instance, a coating or encapsulation may dissolve after having been exposed to a certain amount of water or moisture, such that the amide composition may be exposed from the coating or encapsulation with particularly moist or wet conditions. When the coating or encapsulation dissolves, the amide composition within the coating or encapsulation may be exposed, thereby allowing the amide composition to react with other components of the gypsum slurry and/or gypsum core.

In another aspect, at least a portion of an enzyme composition and/or any components thereof may be coated or encapsulated with one or more encapsulating or coating materials to delay and/or extend the conversion time of an amide composition, such as the conversion time of urea into carbonate and ammonium. For instance, the encapsulation or coating may prevent or inhibit at least a portion of the enzyme composition from coming into contact with water, moisture, and/or an amide composition during the manufacturing process of a gypsum panel. In some aspects, a coating or encapsulation may be capable of dissolving or melting, such as with exposure to water, pressure, and/or temperature. For instance, a coating or encapsulation may dissolve after having been exposed to a certain amount of water or moisture, such that the enzyme composition may be exposed from the coating or encapsulation with particularly moist or wet conditions.

In yet another aspect, an amide composition and/or any components thereof and an enzyme composition and/or any components thereof may be coated or encapsulated together with one or more encapsulating or coating materials to delay and/or extend the conversion time of the amide composition, such as the conversion time of urea into carbonate and ammonium. For instance, the encapsulation or coating may prevent or inhibit at least a portion of the coated or encapsulated mixture from coming into contact with water or moisture during the manufacturing process of a gypsum panel. In some aspects, a coating or encapsulation may be capable of dissolving or melting, such as with exposure to water, pressure, and/or temperature. For instance, a coating or encapsulation may dissolve after having been exposed to a certain amount of water or moisture, such that the coated or encapsulated combination of an amide composition and/or any components thereof and an enzyme composition and/or any components thereof may be exposed from the coating or encapsulation with particularly moist or wet conditions.

Additionally, or in the alternative, in some aspects, a coating or encapsulation may be capable of rupturing, for example when the continuity of a gypsum panel is interrupted such as by fasteners (e.g., nails, screws, etc.) being driven through the cementitious panel or other sources of punctures, cracks, cuts, perforations, or the like. When the coating or encapsulation ruptures, the contents (e.g., enzyme composition and/or any components thereof, amide composition and/or any components thereof) within the coating or encapsulation may be exposed.

Generally, a coating or encapsulating material for forming a coated or encapsulated urea may include polymeric materials, a wax (e.g., paraffin wax, beeswax), a clay, a starch, a cellulose, a chitosan, sulfur, a gelatin, an epoxy resin, sodium alginate, or a combination thereof.

Suitable polymeric materials for forming the coating or encapsulating material may include acrylic polymers (e.g., polyacrylamide, polyacrylate, poly(acrylate-co-acrylamide)), polyvinyl alcohol polymers (e.g., hydrolyzed polyvinyl alcohol), polyamide polymers, polyurethane polymers, polyester polymers, polyether polymers, silicon-based polymers, and co-polymers of any of the foregoing, as well as mixtures of any of the foregoing. Generally, an amide composition and/or any components thereof and an enzyme composition and/or any components thereof may be coated or encapsulated using any desired method known in the art, including physical or chemical methods. Exemplary physical methods include pan coating and air-suspension coating. Exemplary chemical methods include polycondensation, cross-linking, and polymerization.

In general, the thickness of the coating or encapsulation may be selected depending upon the specific application. For a coating or encapsulation that is intended to dissolve or melt, the thickness of the coating may correlate to the degree of exposure necessary or sufficient to dissolve or melt the coating or encapsulation. A coating or encapsulation may have a micro-scale thickness or a nano-scale thickness. In an exemplary embodiment, a coating or encapsulation may have a micro-scale thickness, with an average thickness of from 0.1 to 1,000 micrometers, such as from 0.1 to 900 μm, such as from 0.1 to 500 μm, such as from 0.1 to 250 μm, such as from 0.1 to 100 μm, such as from 0.1 to 50 μm, such as from 1 to 900 μm, such as from 1 to 100 μm, such as from 10 to 500 μm, such as from 10 to 250 μm, such as from 50 to 150 μm, such as from 100 to 250 μm, such as from 250 to 500 μm, such as from 500 to 1,000 μm, such as from 500 to 750 μm, such as from 750 to 1,000 μm. The coating or encapsulation may have an average thickness of at least 0.1 microns, such as at least 1 μm, such as at least 5 μm, such as at least 10 μm, such as at least 25 μm, such as at least 50 μm, such as at least 100 μm, such as at least 150 μm, such as at least 250 μm, such as at least 400 μm, such as at least 600 μm, such as at least 800 μm. The coating or encapsulation may have an average thickness of less than 1,000 microns, such as less than 900 μm, such as less than 700 μm, such as less than 600 μm, such as less than 500 μm, such as less than 350 μm, such as less than 225 μm, such as less than 175 μm, such as less than 125 μm, such as less than 100 μm, such as less than 100 μm, such as less than 75 μm, such as less than 40 μm, such as less than 20 μm, such as less than 10 μm, such as less than 5 μm.

In an exemplary embodiment, a coating or encapsulation may have a nano-scale thickness, with an average thickness of from 0.1 to 1,000 nanometers, such as from 0.1 to 900 nm, such as from 0.1 to 500 nm, such as from 0.1 to 250 nm, such as from 0.1 to 100 nm, such as from 0.1 to 50 nm, such as from 1 to 900 nm, such as from 1 to 100 nm, such as from 10 to 500 nm, such as from 10 to 250 nm, such as from 50 to 150 nm, such as from 100 to 250 nm, such as from 250 to 500 nm, such as from 500 to 1,000 nm, such as from 500 to 750 nm, such as from 750 to 1,000 nm. The coating or encapsulation may have an average thickness of at least 0.1 micrometer, such as at least 1 nm, such as at least 5 nm, such as at least 10 nm, such as at least 25 nm, such as at least 50 nm, such as at least 100 nm, such as at least 150 nm, such as at least 250 nm, such as at least 400 nm, such as at least 600 nm, such as at least 800 nm. The coating or encapsulation may have an average thickness of less than 1,000 micrometer, such as less than 900 nm, such as less than 700 nm, such as less than 600 nm, such as less than 500 nm, such as less than 350 nm, such as less than 225 nm, such as less than 175 nm, such as less than 125 nm, such as less than 100 nm, such as less than 100 nm, such as less than 75 nm, such as less than 40 nm, such as less than 20 nm, such as less than 10 nm, such as less than 5 nm.

In one aspect, the conversion time of an amide composition into the desired conversion products may be delayed and/or extended by an enzyme composition inhibitor. In this respect, the enzyme composition inhibitor may delay or extend the reaction time of any of the components of the amide composition with any of the components of the enzyme composition. The enzyme composition inhibitor may include hydroquinone, a hydroxamic acid, sodium fluoride, thiourea, boric acid, dicyandiamide, n-(n-butyl)thiophosphoric triamide (“NBPT”), n-(n-butyl)phosphoric triamide (“NBPT”), phenyl phosphorodiamidate (“PPD”), or a combination thereof. Generally, the enzyme composition inhibitor may be present in any component of a gypsum panel (e.g., gypsum core, gypsum slurry), in an amount from about 0.0001 wt. % to about 5 wt. %, including all increments of 0.0001 wt. % therebetween. For instance, the enzyme composition inhibitor may be present in an amount of about 0.0001 wt. % or more, such as about 0.001 wt. % or more, such as about 0.01 wt. % or more, such as about 0.02 wt. % or more, such as about 0.025 wt. % or more, such as about 0.05 wt. % or more, such as about 0.1 wt. % or more, such as about 0.2 wt. % or more, such as about 0.3 wt. % or more, such as about 0.4 wt. % or more, such as about 0.5 wt. % or more, such as about 1 wt. % or more, such as about 1.5 wt. % or more, such as about 2 wt. % or more, such as about 3 wt. % or more, such as about 4 wt. % or more. Generally, the enzyme composition inhibitor may be present in an amount of about 5 wt. % or less, such as about 4 wt. % or less, such as about 3 wt. % or less, such as about 2 wt. % or less, such as about 1.5 wt. % or less, such as about 1 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less, such as about 0.025 wt. % or less, such as about 0.02 wt. % or less, such as about 0.015 wt. % or less, such as about 0.01 wt. % or less, such as about 0.001 wt. % or less. The weight percentage may be based on the weight of the amide composition in the gypsum slurry and/or gypsum core. Further, the weight percentage may be based on the weight of the enzyme composition in the gypsum slurry and/or gypsum core.

In general, one or more enzyme compositions and/or any components thereof and/or one or more amide compositions and/or any components thereof may be combined with stucco (i.e., calcium sulfate hemihydrate) before the stucco is reacted with water. In this respect, stucco, one or more enzyme compositions and/or any components thereof, and/or one or more amide compositions and/or any components thereof may be mixed before the resulting mixture is contacted and/or reacted with water. The stucco, one or more enzyme compositions and/or any components thereof, and/or one or more amide compositions and/or any components thereof may be combined by any method known in the art or disclosed herein. For instance, stucco, one or more enzyme compositions, and/or one or more amide compositions may be combined as is or may be ground or milled together, such as by dry milling or wet milling.

Generally, one or more enzyme compositions and/or one or more amide compositions may be milled at any time of the process disclosed herein, including during, before, and/or after any of the process steps disclosed herein. Notably, in one aspect, stucco, one or more enzyme compositions, and/or one or more amide compositions may be mixed and milled (e.g., ball milled) or ground together before being contacted with water to form a gypsum slurry and/or gypsum core. In this respect, the gypsum slurry may comprise a milled mixture of stucco, one or more enzyme compositions, and/or one or more amide compositions. In one aspect, stucco, one or more enzyme compositions, and/or one or more amide compositions may be mixed and milled together before being incorporated into the gypsum slurry.

As previously disclosed, an enzyme composition may be ball-milled, such as by a planetary ball mill. However, it should be understood that an enzyme composition may be milled or ground by other equipment such as, for instance, an attritor, a vibration mill, an impact mill, a jet mill, and the like. Further, an enzyme-producing bacteria and/or one or more biologically-derived enzyme additives (e.g., one or more plant-derived enzyme additives, one or more fungi-derived enzyme additives, one or more algae-derived enzyme additives) may be milled or ground before being incorporated into the gypsum slurry.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, a gypsum panel formed in accordance with the present disclosure may have an enzyme composition and/or any components thereof added to or incorporated in a gypsum slurry and/or gypsum core at any time of the process disclosed herein, including at, before, and/or after any of the process steps disclosed herein. Notably, an enzyme composition may be added to or incorporated in a gypsum slurry and/or gypsum core in any amounts disclosed herein. Further, a gypsum panel formed in accordance with the present disclosure may have an amide composition and/or any components thereof added to or incorporated in a gypsum slurry and/or gypsum core at any time of the process disclosed herein, including at, before, and/or after any of the process steps disclosed herein. Notably, an amide composition may be added to or incorporated in a gypsum slurry and/or gypsum core in any amounts disclosed herein.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry may include an enzyme composition and/or an amide composition. In this regard, the method may include a step of also combining an enzyme composition and/or any components thereof and/or an amide composition and/or any components thereof with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material in the gypsum slurry.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

In one aspect, a gypsum slurry, gypsum core, and/or gypsum panel formed in accordance with the present disclosure may be free of triethanolamine.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

In one aspect, the gypsum slurry and/or gypsum core may include a dispersant, such as a carboxylate or a sulfonate. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco and water. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized or a pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid, or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid, or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, water, an enzyme composition, an amide composition) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as an enzyme composition and/or an amide composition. Notably, an enzyme composition and/or an amide composition may be present in any combination of gypsum core layers. However, in one embodiment, it should be understood that one or two of the aforementioned gypsum core layers may not include an enzyme composition and/or an amide composition. In one aspect, one or more gypsum core layers may comprise the same enzyme composition and/or an amide composition. Further, in one aspect, the one or more gypsum core layers may comprise different enzyme compositions and/or different amide compositions. The different enzyme compositions of the one or more gypsum core layers may be chosen such that it is advantageous to have a particular enzyme composition in one gypsum core layer and a different enzyme composition in another, different gypsum core layer. Further, the different amide compositions of the one or more gypsum core layers may be chosen such that it is advantageous to have a particular amide composition in one gypsum core layer and a different amide composition in another, different gypsum core layer.

The gypsum panel disclosed herein may have many applications. For instance, the gypsum panel may be used as a standalone panel in construction for the preparation of walls, ceilings, floors, roofing, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 50 microns to about 1200 microns, such as about 50 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C473-19 and/or ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C473-19 and/or ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and/or ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and/or ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core formed from a gypsum slurry comprising an enzyme composition and an amide composition, the amide composition being present in the gypsum slurry in an amount from about 0.01 wt. % to about 5 wt. %; and
a first facing material and a second facing material sandwiching the gypsum core.

2. The gypsum panel of claim 1, wherein the enzyme composition comprises a biologically-derived enzyme additive.

3. The gypsum panel of claim 2, wherein the biologically-derived enzyme additive is a plant-derived enzyme additive.

4. The gypsum panel of claim 3, wherein the plant-derived enzyme additive is derived from the seeds, leaves, roots, stems, flowers, and/or fruit of a plant.

5. The gypsum panel of claim 1, wherein the enzyme composition and the amide composition of the gypsum slurry react in the gypsum slurry to form at least one reaction product, wherein the at least one reaction product is a carbonate.

6. The gypsum panel of claim 5, wherein the gypsum slurry comprises one or more cations, wherein the carbonate formed from the reaction of the enzyme composition and the amide composition reacts with the one or more cations to form a metal carbonate.

7. The gypsum panel of claim 6, wherein the metal carbonate is calcium carbonate or magnesium carbonate.

8. The gypsum panel of claim 1, wherein the enzyme composition is present in the gypsum slurry in an amount from about 0.01 wt. % to about 5 wt. %.

9. The gypsum panel of claim 1, wherein the enzyme composition is present in the gypsum slurry in an amount from about 0.01 wt. % to about 3 wt. %.

10. The gypsum panel of claim 1, wherein the enzyme composition has an average particle size from about 1 micron to about 5 mm.

11. The gypsum panel of claim 2, wherein the biologically-derived enzyme additive comprises urease.

12. The gypsum panel of claim 11, wherein the urease is present in the biologically-derived enzyme additive in an amount from about 0.01 wt. % to about 20 wt. %.

13. The gypsum panel of claim 1, wherein the enzyme composition is present in the gypsum panel in an amount from about 0.001 lbs/MSF to about 125 lbs/MSF.

14. The gypsum panel of claim 1, wherein the amide composition comprises urea.

15. The gypsum panel of claim 1, wherein the amide composition has an average particle size from about 500 microns to about 5 mm.

16. The gypsum panel of claim 1, wherein the particle size distribution of the amide composition is such that a US standard mesh size of 10 retains from 90 wt. % to about 100 wt. % of the amide composition.

17. The gypsum panel of claim 1, wherein the amide composition is present in the gypsum slurry in an amount from about 0.01 wt. % to about 3 wt. % based on the weight of the gypsum slurry.

18. The gypsum panel of claim 1, wherein the amide composition has a formaldehyde content from 0 wt. % to about 5 wt. %.

19. The gypsum panel of claim 1, wherein the amide composition has a biuret content from 0 wt. % to about 5 wt. %.

20. A method for making the gypsum panel of claim 1 comprising:
providing a first facing material;
depositing a gypsum slurry comprising stucco, water, an enzyme composition, and an amide composition onto the first facing material, the amide composition being present in the gypsum slurry in an amount from about 0.01 wt. % to about 5 wt. %;
providing a second facing material on the gypsum slurry; and
allowing the stucco to convert to calcium sulfate dihydrate.
